(19) United States
(12) Patent Application Publication
(10) Pub. No.: US 2015/0024352 A1
(43) Pub. Date: Jan. 22, 2015

(54) Noble's Columns

(71) Applicant: Cornelius Barry Noble, Richmond, CA (US)

(72) Inventor: Cornelius Barry Noble, Richmond, CA (US)

(21) Appl. No.: 13/943,938

(22) Filed: Jul. 17, 2013

(51) Int. Cl. G09B 23/02

(52) U.S. Cl. CPC G09B 23/02
USPC 434/209

(57) ABSTRACT

An entire column, written in a specific numerical order, different from traditional multiplication tables, is shown one at a time until all three Noble's Columns of the multipliers and solutions appear together. Without even knowing how to multiply, one can write these columns that end up with multiplication solutions.

### CROSS-REFERENCE TO RELATED APPLICATIONS

Not Applicable

### STATEMENT REGARDING FEDERALLY SPONSORED RESEARCH

Not Applicable

### BACKGROUND OF THE INVENTION

The need to allow people to write multiplication tables before they have even memorized the tables and without copying the tables, led to my inventing Noble's Columns.

### SUMMARY OF THE INVENTION

With my invention, people can end up with written tables for multiplication if they can count from 1 to 9 by ones, or from 2 to 8 by twos.

### DESCRIPTION OF THE DRAWINGS

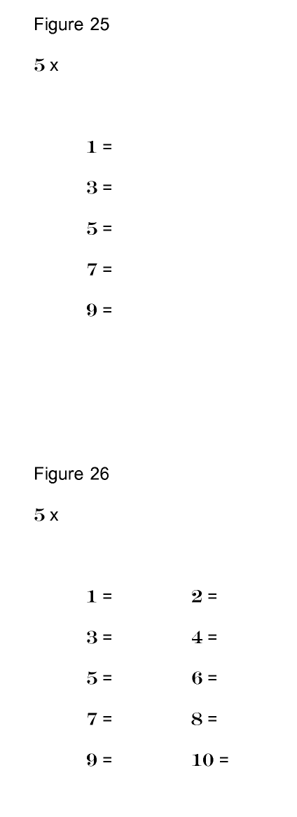

All the figures show the order in which the multiplication tables are to be written to take advantage of the patterns of counting by ones or by twos, with the exception of FIGS. 25 to 31. FIGS. 25 to 31 are created in a manner which highlights the pattern of odd-numbered multipliers resulting in answers ending in “5,” and even-numbered multipliers resulting in answers ending in “0.”

### DETAILED DESCRIPTION OF THE INVENTION

People do not have to know how to multiply in order to write the multiplication tables if they use my invention. Traditionally, one must know the multiplication tables to write them, or after writing the result of a particular table times 1 (7×1 for example), add the number of that table to the previous answer. That is 7+7=14 which is 7×2, 14+7=21 which is 7×3, etc. With my invention, one can write the tables using columns and the 1, 2, 3, 5, 5, 6, 7, 8, 9 pattern or the 2, 4, 6, 8 pattern formed by the answers.

### SEQUENCE LISTING

Not Applicable

### ABSTRACT

People can write multiplication tables without knowing how to multiply. The answers for the multipliers 3, 4, 5, 6, 7, and 8 form patterns which have not been taken advantage of, but can be quickly written almost as easily as they have been for the multiplication tables for 1, 2, and 10 by using my invention for writing the tables.

### APPENDIX FOR DRAWINGS

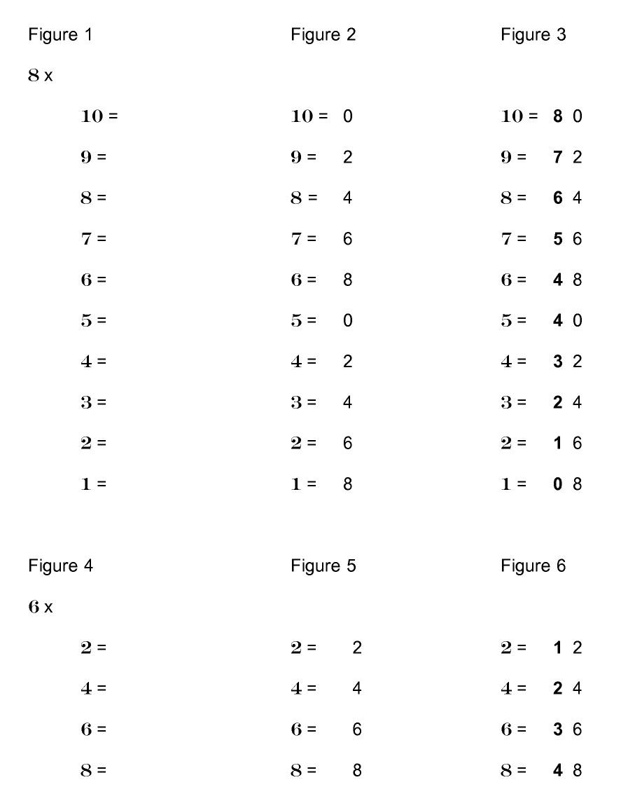

FIG. 1 First column of 8× tables. The first column to appear (do not count the primary multiplier “8×”) starts at the bottom with “1” and goes up increasing by one until it reaches “10.” There will eventually be three columns of numbers. The first column of numbers may be the color of black, and/or a different font from the next two columns of numbers.

FIG. 2 Last column of 8× tables. The second column to appear starts at the top with “0” and travels down increasing by two until it reaches “8” (after which numbers 0 to 8 repeat again). The second column of numbers may be a different color and/or different font from the first column which appears. Though it is the second column written, it is placed in a manner that will allow another column of numbers to be written in front of it.

FIG. 3 Middle column of 8× tables. The third column which appears starts at the bottom with “0” and goes up increasing by one (except where there are two “4's”) until it reaches “8,” and is written in between the other two columns of numbers. The third, and final column of numbers may be a different font and/or color than the previous columns.

FIG. 4 First column of 6× tables. The first column to appear (do not count the primary multiplier “6×”) starts at the top with “2” and goes down increasing by two until it reaches “8.” There will eventually be three columns of numbers. The first column of numbers may be the color of black, and/or a different font from the next two columns of numbers.

FIG. 5 Last column of 6× tables. The second column to appear starts at the top with “2” and as one looks down, sees the numbers increasing by two until the column reaches “8.” The second column of numbers may be a different color and/or a different font from the first column which appears. Though it is the second column written, it is placed in a manner that will allow another column of numbers to be written in front of it.

FIG. 6 Middle column of 6× tables. The third column to appear (seen below in bold) starts at the top with “1” and goes down increasing by one until it reaches “4.” The third, and final column of numbers may be a different color and/or a different font from the previous two columns, and it is written in between the first two columns of numbers.

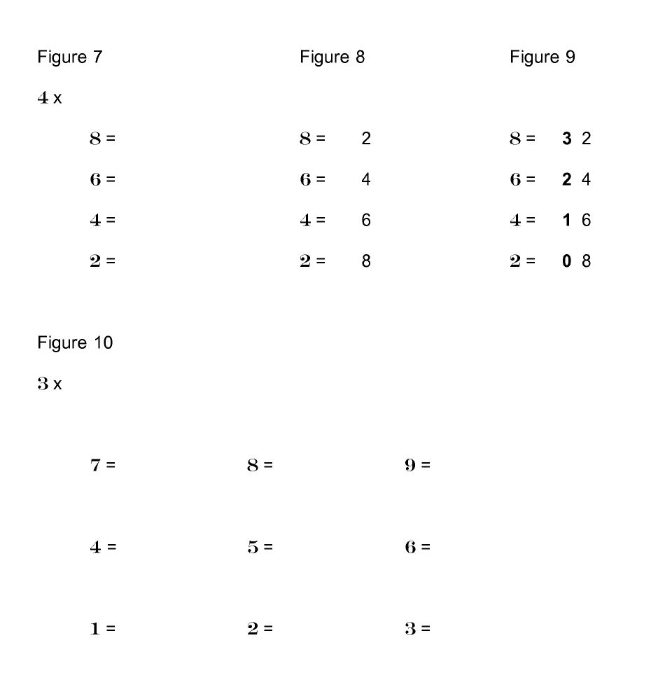

FIG. 7 First column of 4× tables. The first column to appear (do not count the primary multiplier “4×”) starts at the bottom with “2” and goes up increasing by two until it reaches “8.” There will eventually be three columns of numbers. The first column of numbers may be the color of black, and/or a different font from the next two columns of numbers.

FIG. 8 Last column of 4× tables. The second column to appear starts at the top with “2” and as one looks down, sees the numbers increasing by two until the column reaches “8.” The second column of numbers may be a different color and/or a different font from the first column which appears. Though it is the second column written, it is placed in a manner that will allow another column of numbers to be written in front of it.

FIG. 9 Middle column of 4× tables. The third column to appear starts at the bottom with “0” and goes up increasing by 1. The third, and final column of numbers may be a different color and/or a different font from the previous two columns, and it is written in between the first two columns of numbers.

FIG. 10 The first set of 3 by 3 matrices are the 3× tables multipliers.

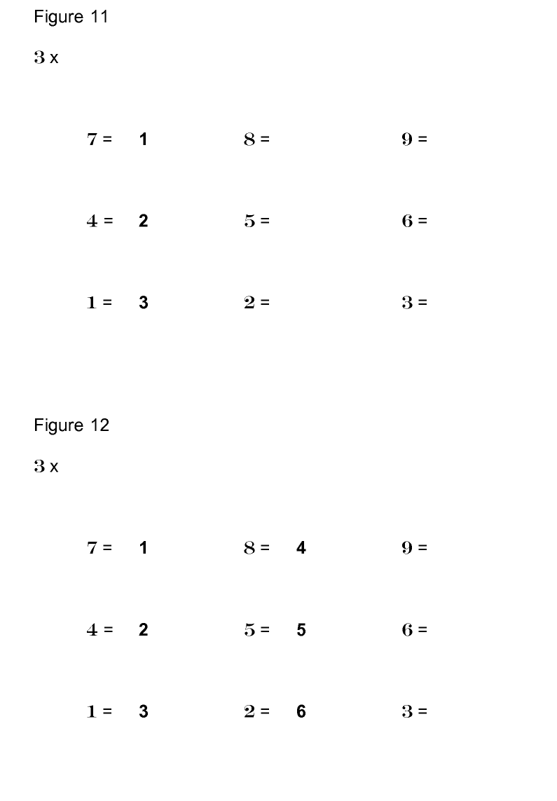

FIG. 11 These are the second digits of the first column of answers, and may be written in a different color and/or a different font from the first columns which appear.

FIG. 12 For 3× tables, these are the second digits of the second column of final answers, and may be written in a different color and/or a different font from the first columns which appear.

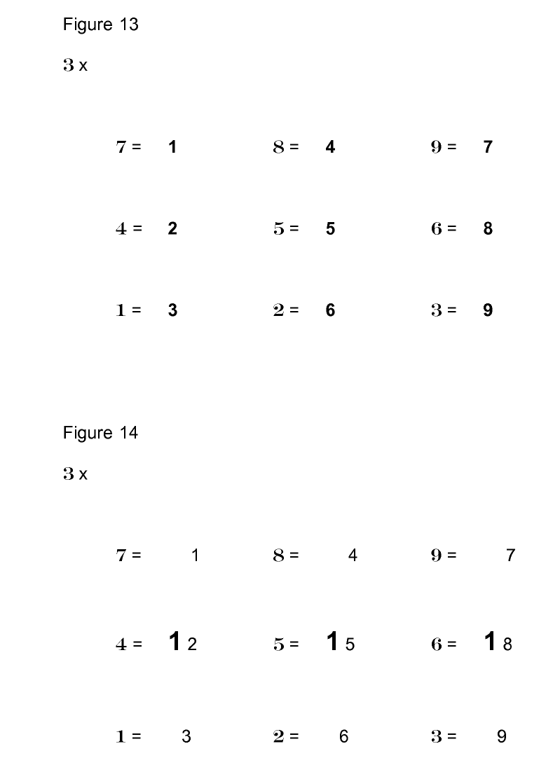

FIG. 13 For 3× tables, these are the second digits of the third column of answers, and may be written in a different color and/or a different font from the first columns which appear.

FIG. 14 For 3× tables, these are the first digits of the middle row of the final answers, and may be a different color and/or a different font from its multiplier and second-digit of answer.

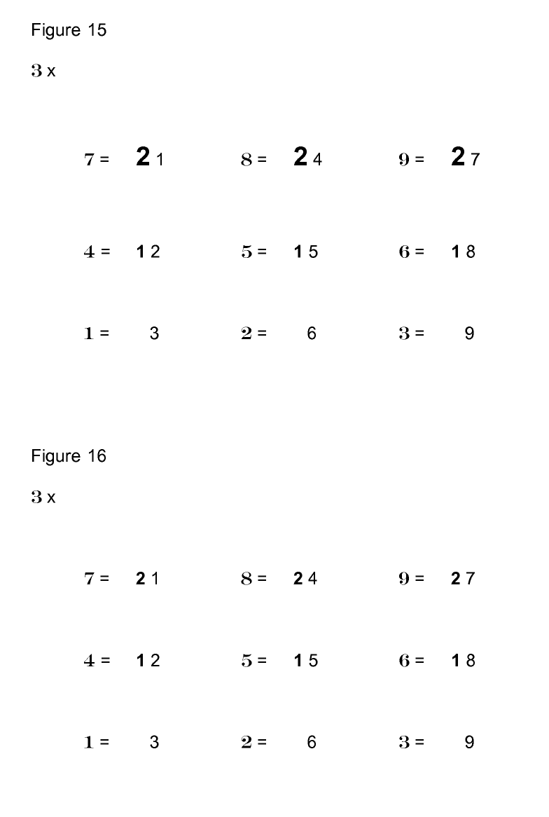

FIG. 15 For 3× tables, these are the first digits of the top row of the final answers, and may be a different color and/or a different font from its multiplier and second-digit of answer.

FIG. 16 These are the 3× tables completed without multiplying.

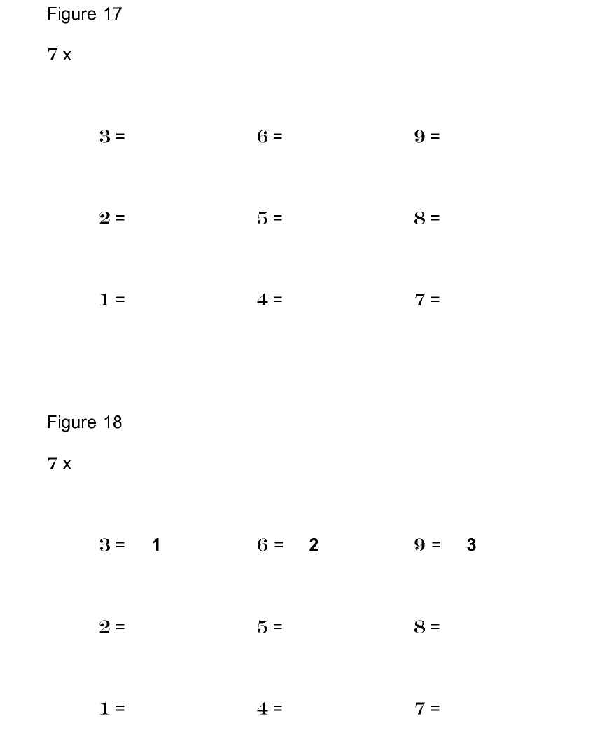

FIG. 17 The first set of 3 by 3 matrices are the 7× tables multipliers.

FIG. 18 For 7× tables, these are the second digits of the first row of final answers, and may be written in a different color and/or a different font from the first columns which appear.

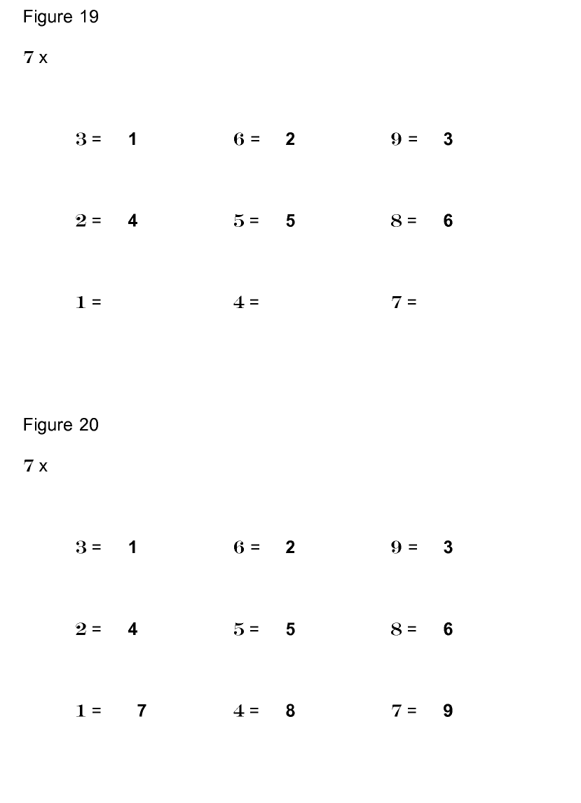

FIG. 19 For 7× tables, these are the second digits of the second row of answers, and may be written in a different color and/or a different font from the first columns which appear.

FIG. 20 For 7× tables, these are the second digits of the third row of answers, and may be written in a different color and/or a different font from the first columns which appear.

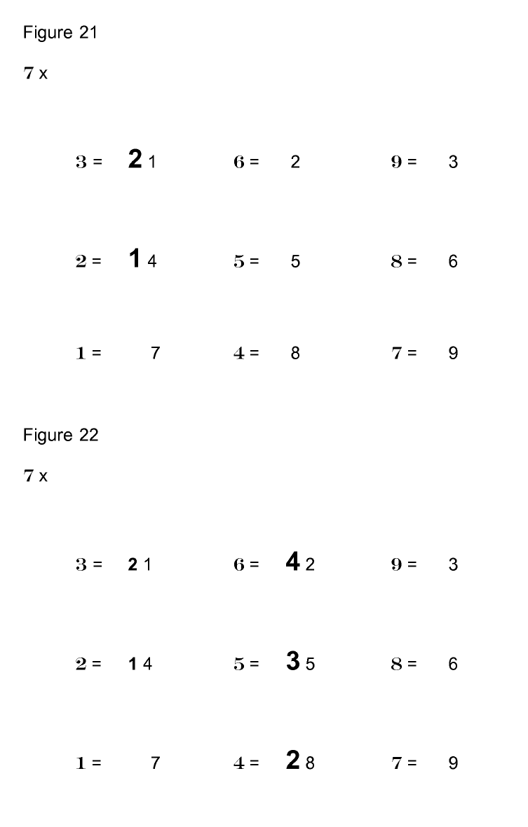

FIG. 21 For 7× tables, these are the first digits of the first column of final answers, and may be a different color and/or a different font from its multiplier and second-digit of answer.

FIG. 22 For 7× tables, these are the first digits of the second column of final answers, and may be a different color and/or a different font from its multiplier and second-digit of answer.

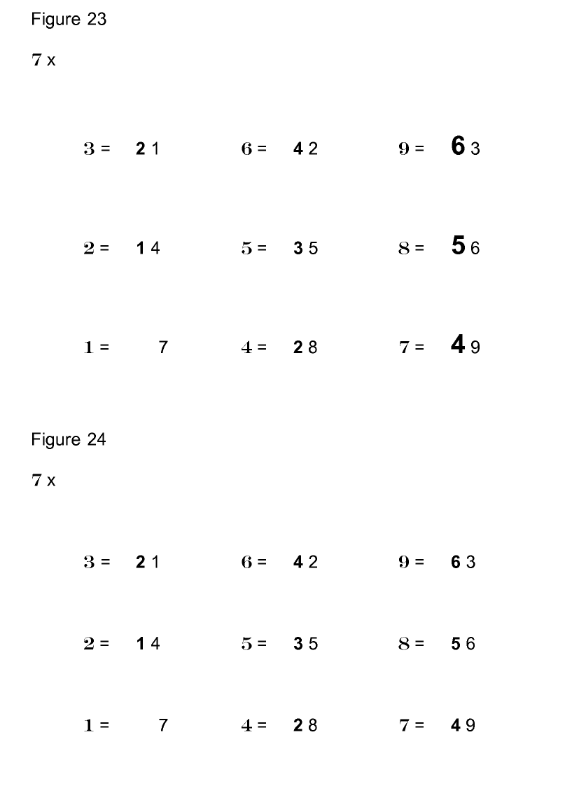

FIG. 23 For 7× tables, these are the first digits of the third column of final answers, and may be a different color and/or a different font from its multiplier and second-digit of answer.

FIG. 24 These are the 7× tables completed without multiplying.

FIG. 25 First column is odd 5× tables multipliers.

FIG. 26 The next column is even 5× tables multipliers.

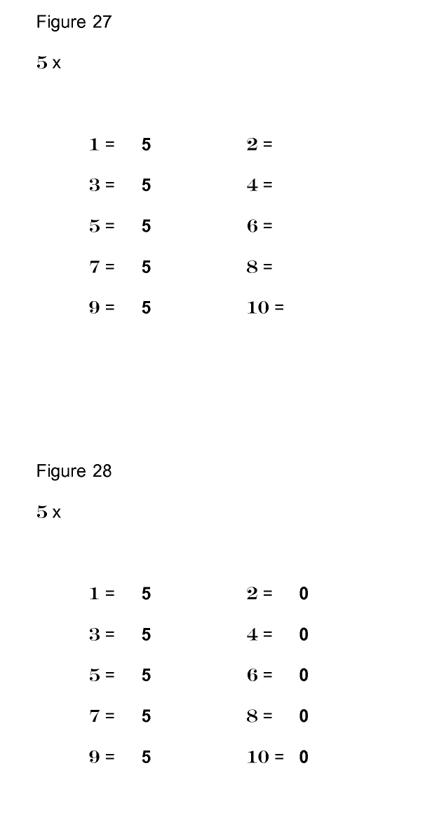

FIG. 27 These are the second digits of the answers for odd 5×multipliers, and may be written in a different color and/or a different font from the first columns which appear.

FIG. 28 These are the second digits of the answers for even 5×multipliers, and may be written in a different color and/or a different font from the first columns which appear.

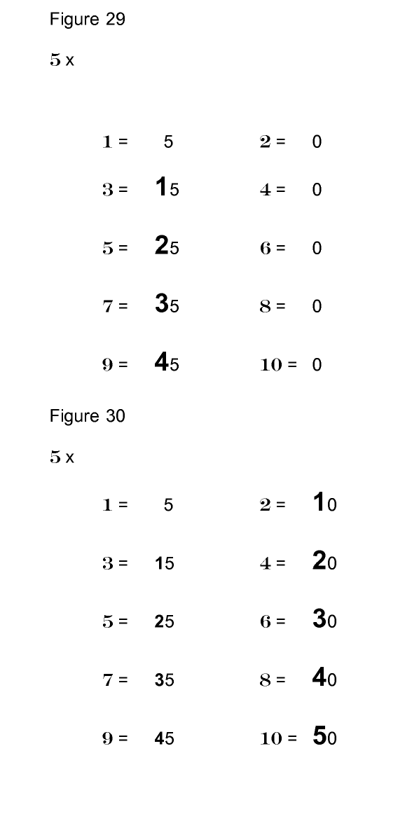

FIG. 29 These are the first digits of the final answers for odd 5×multipliers, and may be a different color and/or a different font from its multiplier and second-digit of answer.

FIG. 30 These are the first digits of the final answers for even 5×multipliers, and may be a different color and/or a different font from its multiplier and second-digit of answer.

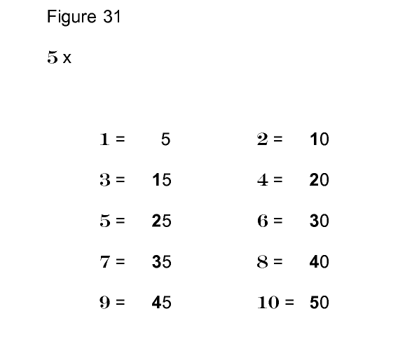

FIG. 31 These are the 5× tables completed without multiplying.

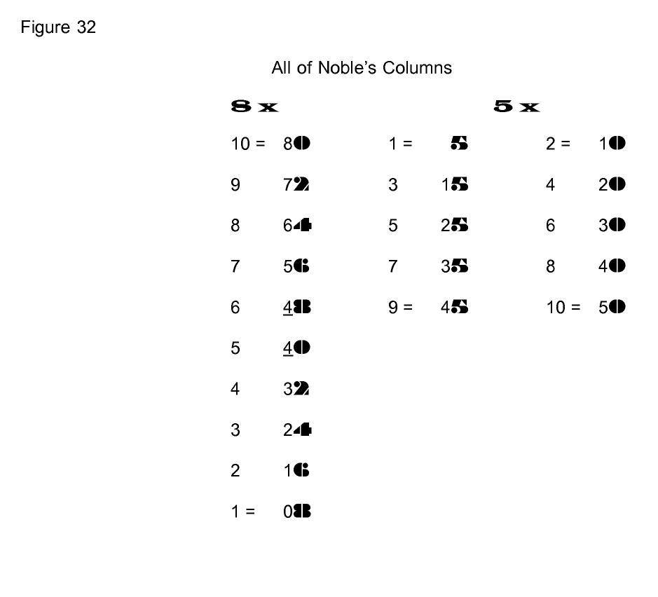

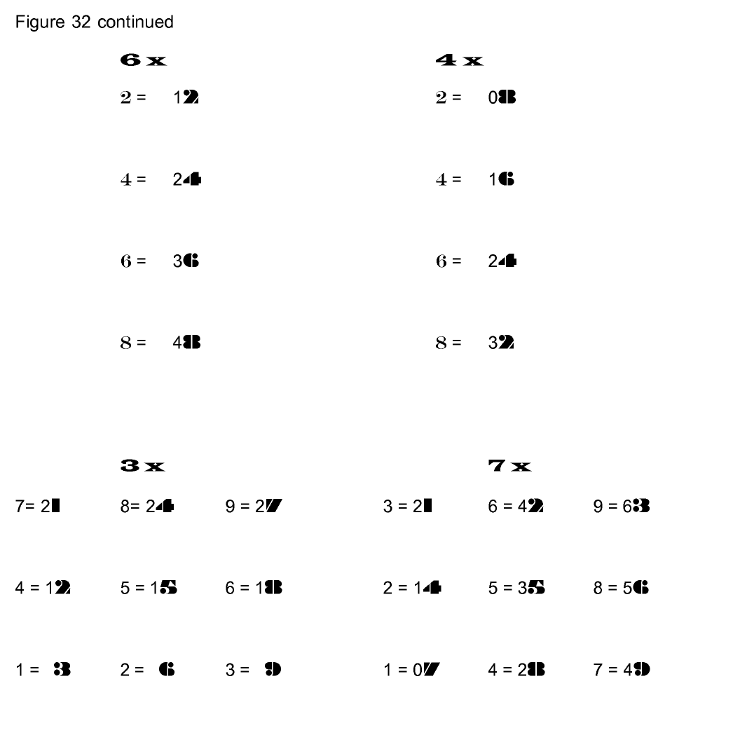

FIG. 32 These are the 3, 4, 5, 6, 7, and 8 times multiplication tables written with the Noble's Columns invention using different fonts to highlight the counting-by-one pattern, or the counting-by-two pattern created by the invention.

1. Traditionally, multiplication tables, are written as:
8×1=8 The next answer is found by adding 8+8 or by knowing 8×2=16, and the next answer is found by adding 16+8 or by knowing 8×3=24, etcetera. That method requires the person to already know the answer he or she is supposed to be trying to learn, or to practice addition (instead of practicing the multiplication they are trying to learn). A claim I am making: with my invention one can write multiplication tables without already knowing the answers.

2. I claim multiplication tables can be written without knowing the answer by writing the numbers that make up the problems and the answer by the columns and the rows in the order in which I specify in the drawings and appendix to the drawings.

3. I claim that if a person writes the multiplication tables using my invention, they can then use these tables to correctly solve basic multiplication problems even though he or she has yet to memorize the answers to basic multiplication problems. My invention differs from the traditional tables used to answer questions by locating them on the traditional tables because my tables can be 1) written just before being utilized, 2) without knowing how to multiply, and 3) written by being able to add to a previous number the number “one” or the number “two.”
